(19) United States
(12) Patent Application Publication
(10) Pub. No.: US 2005/0255981 A1
(43) Pub. Date: Nov. 17, 2005

(54) Machine and method for producing cardboard tubes

(76) Inventor: Fabio Perini, Viareggio (IT)

Correspondence Address: MCGLEW & TUTTLE, PC, P.O. BOX 9227, SCARBOROUGH STATION, SCARBOROUGH, NY, 10510-9227, US

(21) Appl. No.: 10/523,986

(22) PCT Filed: Jul. 25, 2003
(86) PCT No.: PCT/IT03/00457

§ 371 Date: Jun. 27, 2005

(30) Foreign Application Priority Data
Sep. 8, 2002 (IT) FI2002A000154

(51) Int. Cl. B31C 11/04

(52) U.S. Cl. 493/276

(57) ABSTRACT

Cardboard tubes producing machine, comprising means for feeding more paper or paper-like strips or ribbon-shaped material, a part of which is glued in correspondence of the lower surface thereof, for advancing and winding the said strips or ribbon-shaped material forming overlapping and staggered spirals onto a spindle (1), and cutting means for cutting the tube obtained by the advancement and winding of the strips or ribbon-shaped material on the spindle (1), thus obtaining tubular elements having a predetermined length. The machine comprises means (3), positioned upstream of the spindle (1) with respect to the advancing direction of the strips or ribbon-shaped material towards the spindle (1), distributing a predetermined amount of quick setting glue between the surfaces of the penultimate and the last strips or ribbon-shaped material wound on the spindle (1).

The present invention relates to a machine and a method for producing cardboard tubes.

It is known that a machine for producing cardboard tubes basically comprises:
means for continuously feeding two or more ribbon-shaped strips made of paper or similar material, at least one strip being provided with a predetermined amount of glue in correspondence of one of its sides, the strips being drawn from corresponding bobbins which are supported by the feeding means;
belt type means, which are positioned downstream of said feeding means, for winding and advancing said strips onto a spindle, forming a plurality of spirals which are overlapped and staggered according to a predetermined staggering step, so that the tube results from the reciprocal overlapping and gluing of the strips which are spirally wound on the spindle;
means, which are positioned downstream of said spindle, for cutting the continuous tube into elements having a predetermined length.

Obviously, the first strip, i.e. the strip destined to directly contact the spindle, is not glued, to avoid its adhesion to the spindle surface.

In practice, the belt means, which are positioned onto the spindle downstream of with respect to the feeding direction of the strips, drawn the strips by exerting on them a traction force which is directed towards the spindle and, while it is forming, the tube made by the overlapped spiral strips advances and rotates about the longitudinal axis of the spindle.

The intervention rate of the cutting means depends on the advancing speed of the tube onto the spindle and on the predetermined length of the elements obtained from the tube.

Such a machine is described in WO 95/10400 and WO 95/10399.

One of the main drawbacks deriving from of such machines lies in a cleavage of the tube in correspondence of the cut sections. This drawback is even more evident when the operative speed of the machine increases.

The main aim of the present invention is to eliminate the said drawback.

This result has been achieved, according to the invention, by providing an apparatus having the features indicated in the characterizing part of the independent claims. Further characteristics being set forth in the dependent claims.

Thanks to the present invention, it is possible to increase the operative speed of the machine, i.e. the feeding speed of the strips and, consequently, the tubes producing speed, without the aforesaid cleavage effect. Furthermore, a machine according to the present invention is relatively simple to make, cost-effective and reliable even after a prolonged service life and it may also be realized by modifying the existing machines, without adversely affecting the functionality thereof, at a cost which is very low when compared with the advantages which are obtained.

These and other advantages and characteristics of the invention will be best understood by anyone skilled in the art from a reading of the following description in conjunction with the attached drawings given as a practical exemplification of the invention, but not to be considered in a limitative sense, wherein:

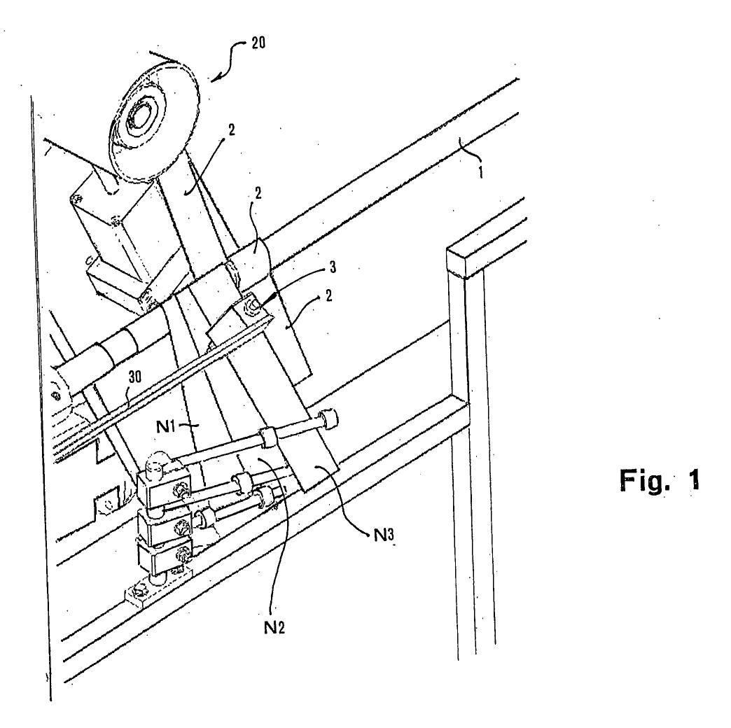

FIG. 1 is a simplified perspective view of the strips inlet section in a machine according to the present invention;

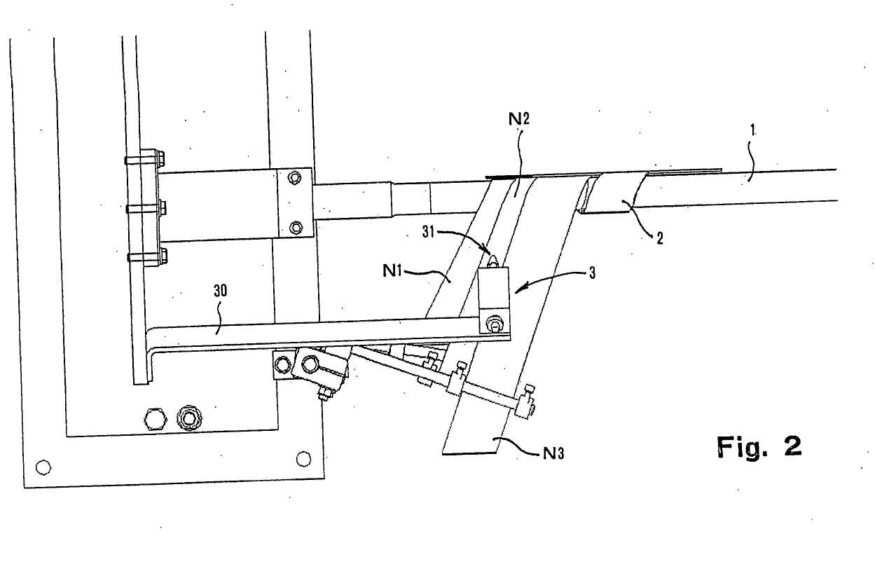

FIG. 2 is a plan view of the device shown in FIG. 1;

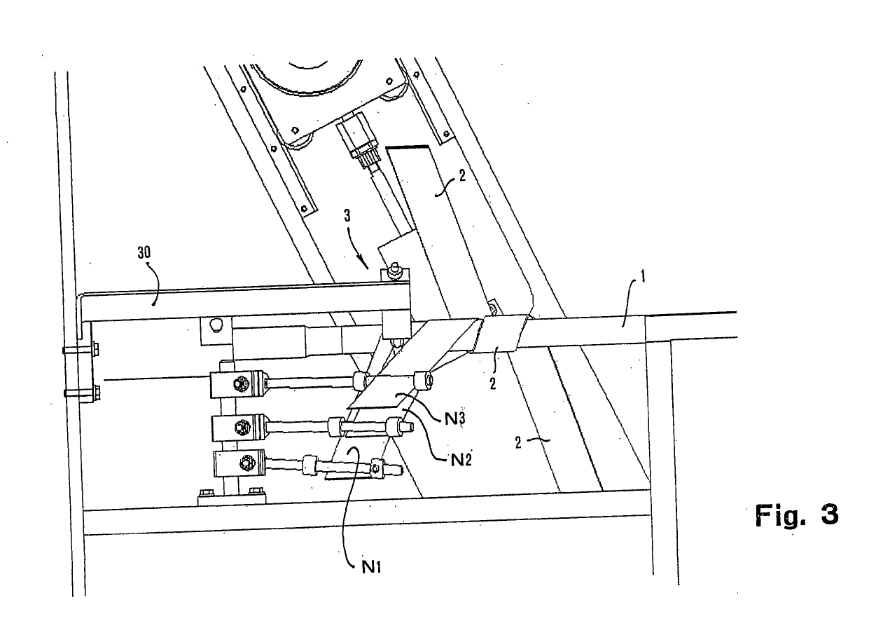

FIG. 3 is a front view of the device shown in FIG. 1;

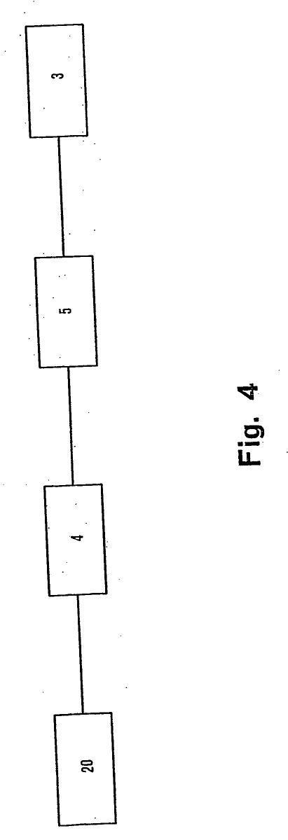

FIG. 4 is a simplified block diagram of a possible control system for the distributor (3);

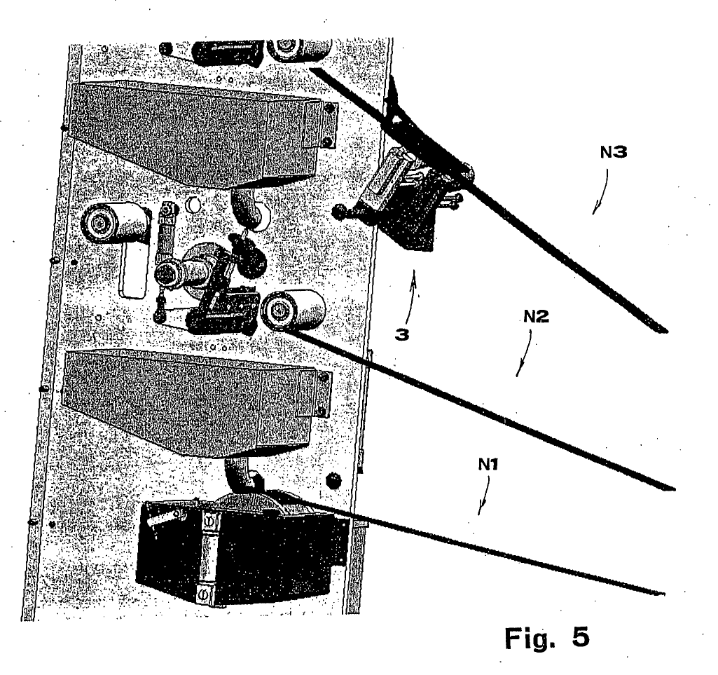

FIG. 5 is a schematic perspective view of a machine according to the present invention seen at a point upstream of the spindle.

Reduced to its basic structure, reference being made to the enclosed drawings, a machine according to the present invention comprises, similarly to the conventional machines:
feeding means for feeding more paper or paper-like strips or ribbon-shaped material (N1, N2, N3), said strips unwinding from corresponding reels (not shown for sake of clarity) supported by the feeding means, said strips, except the first one (N1) which is destined to directly contact the spindle (1) of the machine, being glued in correspondence of their lower surface, i.e. the surface destined to look at the spindle (1);
a spindle (1) which is longitudinally developed along the direction of the tube to be produced, onto said spindle being wounded the strips (N1, N2, N3) forming a plurality of superimposed and staggered spirals;
belt means (2) for spirally winding said strips (N1, N2, N3) onto the spindle (1) and advancing the tube along the spindle axis;
cutting means (not shown for sake of clarity) for subdividing the tube into tubular elements having a predetermined length.

As stated above, the feeding and gluing means acting on the strips (N1, N2, N3), the winding means and the means for cutting the tube (which results from the overlapping and reciprocal gluing of the strips spirally wound onto the spindle) are known to those skilled in the art and, therefore, it is omitted a more detailed description thereof. The gluing of the lower surface of the strips or ribbon-shaped material (N1, N2, N3) is made, according to a known technique, immediately downstream of the reels from which the strips are drawn, i.e. before the strips enter the tube producing machine, by means of liquid glue contained in corresponding tanks onto which the strips advance, the liquid glue exploiting its adhesive power in a relatively long time to avoid that it became dry along the path between the gluing station (i.e. the station where the tanks containing the liquid glue are positioned) and the tube producing machine.

Advantageously, according to the present invention, the present machine comprises means (3) for applying a predetermined amount of quick setting glue to the upper surface (i.e. the surface opposite to that looking at the spindle 1) of at least one of the strips which are wound onto the spindle (1) and, more precisely, to the upper surface of at least one strip preceding the last one.

The wording “quick setting glue” denotes a glue having a high adhesive power acting in a short time.

For example, with reference to FIG. 2 and FIG. 3, the means (3) distribute the quick setting glue on the upper surface of the second of said strips (N1, N2, N3), i.e. on the upper surface of the strip (N2) preceding the last strip (N3).

Obviously, when two strips are to be employed instead of three, the means (3) distribute the glue on the upper surface of the first strip.

According to the example shown in the drawings, said means (3) comprise a distributor apt to distribute “hot melt” glue, whose body is solid to a fixed part (30) of the tube producing machine, in such a manner to result slightly upstream of the spindle (1), and whose nozzle (31) look at the upper surface of the strip to be glued (in the example, the upper surface of the strip N2).

Alternatively, according to the present invention, the said means (3) may act on the lower surface of the last strip instead of the upper surface of penultimate one, i.e. on the lower surface of the second strip if the tube is made up of two strips or on the lower surface of the third strip if the tube is made up of three strips. In that case, the means (3) are positioned on the other side of the strips with respect to the configuration of FIGS. 1, 2 and 3.

In any case, according to present invention, provision is made for applying a predetermined amount of quick setting glue (for example, a “hot melt” glue) in correspondence of the interface between the penultimate strip and the last one.

Furthermore, advantageously, said means (3) may be activated when the advancing speed of the strips or ribbon-shaped material (N1, N2, N3) reaches a predetermined value, so that the means (3) are operative only when the advancing speed of the strips is higher than a predetermined value, avoiding dissipation of glue when the advancing speed of the strips, i.e. the tube producing speed, is so low that the above-mentioned tube cleavage does not arise.

At this end, provision is made for a strips (N1, N2, N3) advancing speed sensor, for example an encoder (4) connected with the motor (20) driving the belt (2)—which determines the advancing and winding of the strips on the spindle—and further connected with an electronic programmable unit (5) apt to receive the speed signals coming from the sensor (4) to activate the means (3) when the speed sensed by the sensor is higher than a programmed value.

The means (3) may distribute the glue continuously or intermittently.

As shown in FIG. 5, said means (3) may also be positioned at a predetermined distance from the spindle (1) and they may be fixed to the structure of the means for feeding the strips or ribbon-shaped material (N1, N2, N3), said feeding means being positioned upstream of the spindle. Practically, all the construction details may vary in any equivalent way as far as the shape, dimensions, elements disposition, nature of the used materials are concerned, without nevertheless departing from the scope of the adopted solution idea and, thereby, remaining within the limits of the protection granted to the present patent for industrial invention.

1) Cardboard tubes producing machine, comprising means for feeding more paper or paper-like strips or ribbon-shaped material, a part of which is glued in correspondence of the lower surface thereof, for advancing and winding the said strips or ribbon-shaped material forming overlapping and staggered spirals onto a spindle, and cutting means for cutting the tube obtained by the advancement and winding of the strips or ribbon-shaped material on the spindle, thus obtaining tubular elements having a predetermined length, characterized in that it comprises means, positioned upstream of the spindle with respect to the advancing direction of the strips or ribbon-shaped material towards the spindle, distributing a predetermined amount of quick setting glue between the surfaces of the penultimate and the last strips or ribbon-shaped material wound on the spindle.

2) Machine according to claim 1 characterized in that it comprises means for sensing the advancing speed of said strips or ribbon-shaped material wound on the spindle, the said quick setting glue distributing means being driven by the said sensing means.

3) Machine according to claim 1 characterized in that the said quick setting glue distributing means comprise a “hot melt” glue distributor.

4) Machine according to claim 1 characterized in that said quick setting glue distributing means comprise a nozzle oriented towards the upper surface of the penultimate strip or ribbon-shaped material.

5) Machine according to claim 1 characterized in that said quick setting glue distributing means comprise a nozzle oriented towards the lower surface of the last strip or ribbon-shaped material.

6) Method for producing cardboard tubes by winding a plurality of strips or ribbon-shaped material onto a spindle, a part of said strips or ribbon-shaped material being glued in correspondence of the lower surface thereof, forming corresponding overlapped and staggered spirals, characterized in that provision is made for applying a predetermined amount of quick setting glue between the surfaces of the penultimate and the last strips or ribbon-shaped materials wound on the spindle.

7) Method according to claim 6 characterized in that said quick setting glue is distributed only when the advancing and winding speed of said strips or ribbon-shaped material is higher than a predetermined value.

8) Method according to claim 6 characterized in that the quick setting glue is a “hot melt” glue.

9) Method according to claim 6 characterized in that the quick setting glue is distributed on the upper surface of the penultimate strip or ribbon-shaped material.

10) Method according c to claim 6 characterized in that the quick setting glue is distributed on the lower surface of the last strip or ribbon-shaped material.
